(19) United States
(12) Patent Application Publication
(10) Pub. No.: US 2020/0305239 A1
(43) Pub. Date: Sep. 24, 2020

(54) PUNCTURE-RESISTANT SHEET HEATER AND STRUCTURES MADE THEREWITH

(71) Applicants: DUPONT ELECTRONICS, INC., Wilmington, DE (US); DDP SPECIALTY ELECTRONIC MATERIALS US, INC., Collegeville, PA (US)

(72) Inventors: Wei Wu, HOCKESSIN, DE (US); GREGORY SCOTT BLACKMAN, MEDIA, PA (US); Stephane Costeux, Midland, MI (US); James Neal Singletary, Midlothian, VA (US)

(21) Appl. No.: 16/825,689

(22) Filed: Mar. 20, 2020

Related U.S. Application Data
(60) Provisional application No. 62/822,404, filed on Mar. 22, 2019.

(51) Int. Cl. H05B 3/18; H05B 3/36; E01C 11/26

(52) U.S. Cl. CPC H05B 3/18; E01C 11/265; H05B 3/36

(57) ABSTRACT

A puncture-resistant, electrically-energized sheet heater comprises a conductive polymeric film laminated between a top puncture-resistant, polymeric protective layer and a bottom backing layer that may comprise an insulated backing layer of extruded polystyrene closed-cell foam board. The heater is appointed to be placed beneath, or embedded in, a pavement material, and energized to provide heat to remove frozen precipitation from the pavement, or prevent it from accumulating thereon.

### CROSS-REFERENCE TO RELATED APPLICATION

This application claims benefit under 35 USC 119(e) of U.S. Provisional Application Ser. No. 62/822,404, filed Mar. 22, 2019, which application is incorporated herein for all purposes by reference thereto.

### FIELD OF THE INVENTION

The present disclosure relates to a puncture-resistant, sheet-form heater that is usefully incorporated in a variety of structures such as roads, parking garages, sidewalks, runways, and the like, as well as in building roofs and like structures. More particularly, the disclosure provides a layered article of manufacture that comprises one or more puncture-resistant layers, an electrically conductive layer that can be heated by passing electrical current through it, and an insulative backing layer, a process for constructing such an article, and structures in which such articles may be embedded. The heater is adapted to produce heat to remove build-up of frozen precipitation from the structures.

### TECHNICAL BACKGROUND

Unprotected outdoor surfaces such as roads, bridges, airport runways, sidewalks, and the like are subject to a build-up of snow, sleet, freezing rain, hail, or other frozen precipitation during winter in many climates. The presence of any such precipitation (collectively termed “frozen precipitation” in the present disclosure) is an obvious safety hazard, both for vehicles and pedestrians.

Governments and private entities spend billions of dollars annually removing this frozen precipitation by blowing, plowing, or other mechanical means, or by applying salt or other chemicals that promote ice melting. However, it is often difficult to completely remove the ice. Even a small amount remaining may still result in hazardous conditions. Residual ice can melt and thereafter re-freeze (particularly during a cold night), resulting in what is often termed “black ice,” because of the difficulty seeing it on asphalt or other like surfaces.

In some locations such as sidewalks, where the traffic levels and resulting hazards are particularly high, in situ heat sources are sometimes provided to promote melting of frozen precipitation that cannot be readily removed by the foregoing mechanical or chemical means. For example, sidewalks are sometimes constructed with tubes embedded therein, through which heated water or other fluid can be circulated as a heat source. Alternatively, heating wires can be embedded, so that heat can be provided by passing an electrical current through them. Buildings are also subject to structural damage due to loading of accumulated frozen precipitation and water damage from ice dams.

Nevertheless, better solutions for providing in situ heat are desired, particularly ones that provide one or more of improved mechanical and electrical robustness, ease and efficiency of installation, and improved removal of frozen precipitation with minimal energy input.

### SUMMARY

An aspect of the present disclosure provides a puncture-resistant, electrically-energized sheet heater comprising:
(a) a flexible heater element having top and bottom surfaces;
(b) a puncture-resistant, polymeric protective layer laminated to the top surface of the flexible heater element;
(c) an insulating backing layer laminated to the bottom surface of the flexible heater element; and
(d) electrical terminals electrically connected to the flexible heater element, and configured such that current supplied by an electrical energy source and presented at the electrical terminals flows through the flexible heater element, whereby heat is produced by the heater.

Another aspect provides a heater system comprising a sheet heater of the foregoing type and an electrical energy source electrically connected to the terminals of the heater.

Still another aspect provides a heated paving module comprising a paver stone and a heater of the foregoing type associated with the paver stone.

Yet another aspect provides a road, constructed with a pavement material that is at least one of concrete or bituminous asphalt and comprising a sheet heater as recited above and situated beneath, or embedded in, the pavement material.

A still further aspect provides a method for removing, or preventing build-up, of frozen precipitation from a paved road surface of a road, path, sidewalk, or the like comprising:
(a) providing a heater system as recited above;
(b) thermally contacting the heater with the pavement material; and
(c) energizing the heater sufficiently to maintain the road surface free of the frozen precipitation.

### BRIEF DESCRIPTION OF THE DRAWINGS

The invention will be more fully understood and further advantages will become apparent when reference is made to the following detailed description of the preferred embodiments of the invention and the accompanying drawings, wherein like reference numerals denote similar elements throughout the several views and in which:

FIG. 1 depicts in side cross-section view a portion of a heater structure in accordance with the invention;

FIG. 2 depicts in side cross-section view another embodiment of the present heater structure having two layers of heater element; and

FIG. 3 depicts a graph showing the heating of a simulated road surface using a heater structure of the present disclosure.

### DETAILED DESCRIPTION

Various aspects of the present disclosure relate to a sheet-form heater that is readily incorporated in structures such as roads, bridges, parking decks, aircraft runways, sidewalks, and the like, that are exposed to the elements, so that frozen precipitation can build up on them, creating hazards to vehicle traffic and pedestrians. Electrically energizing the heater facilitates the removal of accumulated frozen precipitation and thus enhances public safety. (Unless otherwise indicated by the context, the term “road” is used herein to refer generically to any of the foregoing structures on which pedestrians, vehicles of any type, or aircraft are appointed to pass, and which are paved with any known pavement material including, without limitation, concrete, bituminous asphalt, macadam, blacktop, and paving bricks or blocks of various compositions.)

Certain embodiments of the present heater are also useful in other building and construction applications, including as roof underlayment for flat or pitched configurations.

Various embodiments of the present disclosure ameliorate difficulties with prior methods of providing external heat. For example, tubing or other conduits are sometimes embedded in pavement material, so that heat can be provided by a fluid circulating therethrough. (Although any liquid or gaseous fluid could be used, heated water is most common. For simplicity, references herein to “water” as a heating fluid are to be understood as encompassing any other suitable alternative fluid.) However, embedding the tubing makes for expensive and tedious construction. In addition, post-installation maintenance, including repair of leaks, is difficult or impossible, as the heater function depends on unobstructed flow of fluid. Using tubing also undesirably localizes the delivery of heat, whereas a heat source that delivered heat more uniformly over an entire desired area would be beneficial.

Embedded tubes are also subject to damage during construction. Typical asphalt and concrete paving materials include hard solids like crushed rock, stone, or other aggregate, which ordinarily have sharp, non-conformal vertices or edges that can easily penetrate or crush the tubes, compromising their ability to carry fluid without obstruction or leakage. Embedded current-carrying wires are similarly vulnerable to mechanical damage from pavement aggregate.

In contrast, an embodiment of the present sheet-form electrical heater provides a distributed conduction path, so that localized damage does not markedly affect the heater's overall conductivity or ability to produce distributed heat. Additional mechanical protection is afforded by sandwiching the conductive layer between at least one top puncture-resistant layer and a rear protective layer, such as an insulative foam backing layer. The distributed conductivity of the heater in many embodiments also inherently causes heat to be generated substantially uniformly over the entire heater surface.

Fluid-circulating systems also are not readily implemented in modular forms, wherein multiple pre-manufactured tiles of regularly shaped concrete, fired-clay bricks or the like (often termed “paving stones” or simply “pavers”) are assembled in the field to fabricate a desired pavement shape. By contrast, the present sheet-form electrical heater better accommodates modular fabrication and assembly, since electrical connections are generally easier to make in the field than fluid connections.

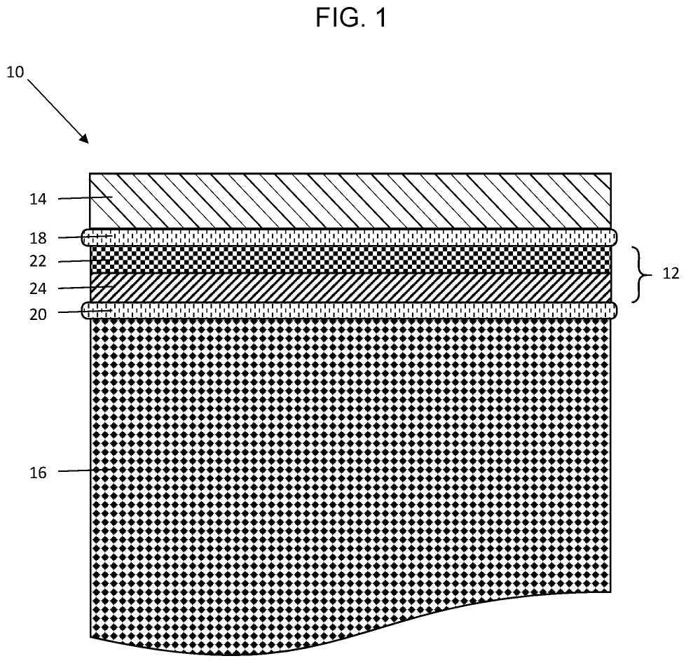

One aspect of the present disclosure provides a puncture-resistant, sheet-form heater having a plurality of layers, including a heater element having top and bottom surfaces, a puncture-resistant protective layer laminated to the top surface and a backing layer laminated to the bottom surface. In most implementations, but not all, the heater element is flexible. A representative embodiment of such a heater is depicted generally at 10 in FIG. 1. Heater 10 comprises a heater element 12 formed of a conductive polymer film, with a puncture-resistant protective layer 14 laminated to the top surface of the heater element and a foam backing layer 16 laminated to the bottom surface.

In an embodiment, the heater element is a conductive polyimide film, such as DuPont Kapton® RS Polyimide, available from E. I. du Pont de Nemours and Company, Wilmington, Del. This film is approximately 50 μm thick and comprises two polyimide sub-layers, one 22 being electrically conductive with a surface resistivity of about 100 Ω/square and the other a dielectric insulator 24. The conductivity of the Kapton® RS Polyimide film is understood to be provided by a carbon-based conductive material that is dispersed uniformly throughout the conductive sub-layer 22. As a result of the dispersion of the conductive material, defects such as punctures, holes, or tears affect the current flow only in the immediate vicinity of the defect and so do not markedly affect the overall conduction pattern or disrupt the overall uniform generation of heat when the layer is energized. A related embodiment (not shown) employs a three-layer polyimide film, wherein a central conductive sub-layer has insulative, dielectric sub-layers on each of its faces to inhibit inadvertent shorting or leakage currents.

Other heating elements having suitable electrical and mechanical properties may also be used. In certain embodiments, any type of film having a surface resistance of 10-500 Ω/square may used. Other polymeric films that are suitably conductive may be used, including ones with a metallized layer or dispersed metallic or non-metallic conductive particles, or one fabricated with any suitable conductive polymer.

Alternatively, a mesh of conductive fibers, whether metallic or of other conductive materials may also be used, provided there are sufficient alternative parallel conduction paths, so that the effect of a localized defect or breach does not markedly disrupt the production of heat uniformly across the area of the heater element. Terminals electrically connected to the heater element are provided in any manner known to a skilled person, permitting the element to be connected to an external power source, so that it produces heat when energized. The power source is most commonly provided by the electric utility grid, but other sources may also be used.

In an embodiment, the lamination of puncture-resistant protective layer 14 is done with a thermally conductive, pressure sensitive adhesive 18 present over substantially the entire area of the heater element. Alternatively, the lamination may be done by any technique involving adhesive bonding, stitching, solvent or thermal welding, or the like, that provides sufficient attachment to secure the protective layer during manufacture, shipment, installation, and end use. In some implementations, the heater element may be provided with perforations that facilitate adhesion to adjacent layers, either by allowing an adhesive or a cast material to create interlocking bonding.

Top layer 14 is constructed with a material that is puncture resistant to protect heater element 12 beneath. It is preferred that layer 14 be thin enough to allow easy transfer of heat from heater element 12 to pavement above. Suitable materials for layer 14 include, without limitation, ultra high molecular weight polyethylene (UHMWPE) sheets and sheets made from para-aramid fibers such as DuPont Kevlar® para-aramid. Other sheet-form materials that afford sufficient mechanical protection and are sufficiently thermally conductive to permit heat from the operating heater element to reach the area appointed to be warmed may also be used. Such materials include, without limitation, woven and non-woven fabrics and laminates containing polyester, polyamide, polyethylene and polypropylene filament yarns and films, fibers of glass or other refractories, and/or sheets of polycarbonate or other puncture resistant polymers.

In some embodiments, layer 14 has a relatively high in-plane thermal conductivity, permitting it to act additionally as a heat spreader to improve the uniformity of heat reaching the pavement above. Materials in this class include multilayer UHMWPE sheets. Since individual UHMWPE sheets typically have an anisotropic conductivity that is much higher in the machine direction than the transverse direction, stacks are frequently prepared by laminating an even number of sheets in orthogonal, cross-ply alternation. Puncture resistance is also improved by such alternation. Polyolefin materials such as polyethylene and polypropylene are beneficially stable in an alkaline environment, such as that presented in contact with concrete. Polyolefins are also beneficial in providing electrical insulation for an underlying electrified heater. Representative examples are disclosed in commonly owned US Patent Application Publication US 2017/0373360A1 to Burkhardt et al., which is incorporated herein in its entirety for all purposes by reference thereto. Materials of this type are available commercially as DUPONT™ TEMPRION™ OHS Organic Heat Spreader (available from E. I. du Pont de Nemours and Company, Wilmington, Del.).

Puncture resistance of a film material is conveniently characterized using a punch and anvil system. For example, a sample of material about 10 cm square may be situated on a steel anvil having a 1 cm, centrally located hole. A punch having a hemispherical tip with a 1 mm radius may be driven perpendicularly into the sheet at a constant rate of 5.08 cm/min using a conventional testing machine, so that the maximum force required to puncture the film may be measured. In an embodiment, materials suitable for the present heater structure may have a puncture force of at least 200, 300, 400, 500, 600, or 700 N-m²/kg normalized to the basis weight (i.e., weight per unit area) of the film.

Some embodiments may further include a layer of heat spreading material between heater element 12 and top layer 14, such as a layer of highly thermally conductive graphite. A representative example is Neograf eGraf Spreadershield (available from Sur-Seal Corporation, Cincinnati, Ohio).

In an embodiment, a foam board, which functions as backing layer 16, is laminated to the bottom surface of the heater element. Suitable boards include, without limitation, closed-cell polystyrene foam boards available from Dow Chemical, Midland, Mich. in grades designated as STYROFOAM™ Highload 40, 60, or 100 Extruded Polystyrene, depending on their compression strength. Ideally, backing layer 16 imparts one or more useful characteristics to the sheet heater. A low thermal conductivity is preferable, to insulate the heater from earth or other cold substrates beneath, improving efficiency by causing heat generated by the heater element to flow predominantly upward to the surface on which frozen precipitation would collect, rather than escaping ineffectually to the underlying ground. By conforming to the profile of a roadbed or other substrate, the foam underlayer protects the heater from mechanical damage, e.g. from rocks in the substrate with jagged edges or protrusions that might otherwise damage the heater element, either during construction or use thereafter. In some embodiments, the board or other insulating layer is sufficiently thin that the entire laminated structure retains some degree of flexibility, so that it can be used over substrates that are not completely flat. The board may be laminated to the heater element above it by any suitable means, including a pressure sensitive adhesive 20 that preferably has low thermal conductivity.

Depending on the end-use application, other types of bottom layers may be used, including both foam boards of other grades or types or other sheet-form products. In an embodiment, the bottom layer may comprise any plastic material that can be blown into foam. Suitable thermoplastics include polyolefins and alkenyl aromatic polymers. Suitable polyolefins include polyethylene and polypropylene. Suitable alkenyl aromatic polymers include polystyrene and copolymers of styrene and other monomers. Suitable polyethylenes include those of high, medium, low, linear low, and ultra low density types. It is also possible to form foam boards from thermoset polymers such as polyisocyanurate or rigid polyurethane. Thermoplastics are preferred over thermoset polymers in below-grade insulating applications because of the tendency of the latter to absorb water.

In an embodiment, the bottom layer comprises a foam structure of an alkenyl aromatic polymer material. Suitable alkenyl aromatic polymer materials include alkenyl aromatic homopolymers and copolymers of alkenyl aromatic compounds and copolymerizable ethylenically unsaturated comonomers. The alkenyl aromatic polymer material may further include minor proportions of non-alkenyl aromatic polymers. The alkenyl aromatic polymer material may be comprised solely of one or more alkenyl aromatic homopolymers, one or more alkenyl aromatic copolymers, a blend of one or more of each of alkenyl aromatic homopolymers and copolymers, or blends of any of the foregoing with a non-alkenyl aromatic polymer. Regardless of composition, the alkenyl aromatic polymer material comprises greater than 50 and preferably greater than 70 weight percent alkenyl aromatic monomeric units. In some embodiments, the alkenyl aromatic polymer material is comprised entirely of alkenyl aromatic monomeric units.

Suitable alkenyl aromatic polymers include those derived from alkenyl aromatic compounds such as styrene, alphamethylstyrene, ethylstyrene, vinyl benzene, vinyl toluene, chlorostyrene, and bromostyrene. A preferred alkenyl aromatic polymer is polystyrene. Minor amounts of monoethylenically unsaturated compounds such as C2-6 alkyl acids and esters, ionomeric derivatives, and C4-6 dienes may be copolymerized with alkenyl aromatic compounds. Examples of copolymerizable compounds include acrylonitrile, acrylic acid, methacrylic acid, ethacrylic acid, maleic acid, itaconic acid, maleic anhydride, methyl acrylate, ethyl acrylate, isobutyl acrylate, n-butyl acrylate, methyl methacrylate, vinyl acetate and butadiene, in amounts consistent with maintaining an adequately low water retention behavior. Embodiments beneficially comprise greater than 80 percent of polystyrene and can be made entirely of polystyrene.

Rigid foam boards particularly useful in the present structure include polystyrene and expanded polystyrene bead foam (bead board or particle board). Extruded polystyrene foams are preferred because they provide relatively high compressive strength and modulus, are relatively impermeable to water and water vapor, and are capable of retaining insulating cell gas for long periods of time. Extruded polystyrene foams are further preferred because they provide sufficient mechanical strength to substantially retain the shape of grooves or other surface features which have been cut, pressed, or embossed in a face of the board.

In some embodiments, the foam structure incorporates one or more additives, such as inorganic fillers, nucleating agents, pigments, antioxidants, acid scavengers, infrared attenuators, ultraviolet absorbers, flame retardants, processing aids, extrusion aids, and the like. The foam board may be closed cell or open cell according to ASTM D2856-87. While open-cell foams allow water to permeate through the foam and drain to the ground underneath, this is detrimental to the insulation properties of the foam. Therefore an open cell content lower that 20% is preferred. More preferably the open cell content is lower than 10%, and most preferably lower than 5%. In various embodiments, water absorption is below 10%, 5%, 2%, or 1% as measured according to ASTM D2842-90. In some embodiments, the top or bottom surface of the board, or both, may further include surface features such as grooves, channels, or the like, that permit any water that would otherwise intrude into the board to drain away into the underlying ground.

The foam board in various embodiments has a density of from about 10 to about 150 or from about 10 to about 70 kilograms per cubic meter according to ASTM D-1622-88. The foam has an average cell size of from about 0.01 to about 5.0, preferably from about 0.1 to about 0.5 and more preferably 0.15 to about 0.3 millimeters according to ASTM D3576-77.

Compressive strength at the lower of 5% deformation or yield point, according to ASTM 1621-73, may be at least 20, 30, 34, or 40 psi, and as much as 60 or 100 psi or more. The desired value of compressive strength depends in large measure on the expected loading of the pavement above the heater structure, with the higher values needed for heavy trucks or aircraft, whereas pedestrian walkways or light duty vehicles do not require as much strength.

Typical foam boards useful in the present heater provide a thermal resistance of R2-15 per inch, measured in ft²·hr·F/BTU/in at 75° F. according to ASTM C-518-91. A desired level of about R-10 may thus be obtained with a 2 in thick board exhibiting R-5/in.

In other embodiments, the bottom insulating layer may be foamed concrete, a fibrous material such as rock or mineral wool, or a silicone rubber in any suitable form.

In another embodiment, the bottom protective layer is provided by a second puncture-resistant layer laminated to the bottom side of the heater element. This layer may be of the same type as the first puncture-resistant layer or a different type. Its presence affords additional protection against penetration from beneath. Optionally, the construction includes both the second puncture-resistant layer in contact with the heater element and an insulating layer, such as the foam board as described above, disposed beneath the puncture-resistant layer, to provide still greater protection.

The heater in any of the embodiments of the present disclosure further comprises electrical terminals that are connected to the heater element and configured to be connected to an electrical source appointed to energize the heater. Any suitable type of terminal may be included. Optionally, the heater may further include a thermostat or other like temperature sensing or control element that permits the flow of electricity to be regulated, so that the desired level of heating is obtained. In some embodiments, a temperature sensing or control element is located externally, or in association with the road surface, so that control can be based on the ambient atmospheric temperature or the road surface temperature. Such embodiments beneficially permit the heating to be regulated, either to activate the heater before frozen precipitation actually collects or to activate it upon detection of frozen precipitation being present on the road surface or its vicinity.

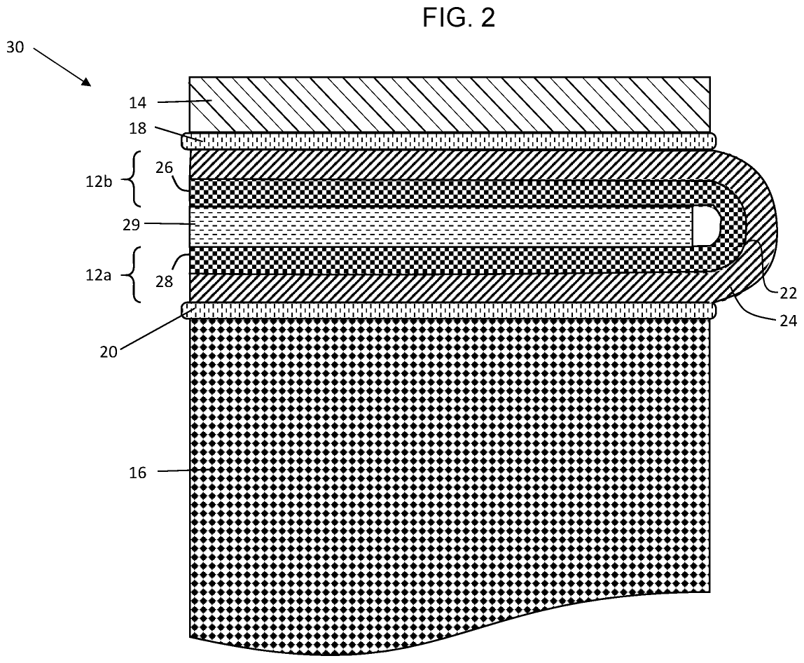

Another embodiment 30 of the present heater is illustrated in FIG. 2. It includes two layers of heater element 12a, 12b composed of Kapton® RS Polyimide. As depicted, the layers of the heating element are formed by folding a single piece of the conductive material back on itself, so that a continuous electrical path is provided between terminal ends 26 and 28. When the heater element is electrically energized, at terminal ends 26 and 28, current enters at one terminal end (e.g., 26), then flows down one layer and returns through the other layer to the other terminal end (e.g., 28). The paired, oppositely-directed current flows thereby minimize the amount of magnetic field and other electrical interference produced in the vicinity of the heater. A dielectric layer 29, such as a polyimide, a meta-aramid, a polyester, or other convenient polymeric material, is situated between the respective conductive portions 22 in the two layers 12a, 12b to prevent any shorting between them. Dielectric layer 29 could be eliminated if the film were folded with the film dielectric sublayers 24 in facing relationship, instead of conductive sublayers 22. In another alternative, two discrete pieces of conductive material could be used instead of a single conductive layer folded back on itself, along with an external electrical connection to replace the fold and made at the end opposite terminal ends 26, 28.

In still another embodiment, the configuration shown in FIG. 1 is modified by adding a conductive metal ground plane on either or both sides of heater element 12, and between protective layer 14 and backing layer 16. Either ground plane can be fabricated either of a thin metal foil (e.g., Cu or Al) or a metallized polymer. The ground plane can be secured to the layers adjacent by any convenient means including pressure sensitive adhesive. An additional level of safety is provided by connecting the ground plane(s) to earth ground, so that any leakage current from heater element 12 does not create a shock hazard.

Another aspect of the present disclosure provides a road (as defined above) in which the present sheet heater is embedded. Roads are commonly constructed by preparing a roadbed in which a layer of relatively coarse crushed rock or the like is placed over the underlying soil and then one or more additional layers of finer rock, sand, or the like are dispersed. The roadbed is then compacted. Thereafter, a road surface layer of concrete, bituminous asphalt, or the like is deposited and finished, which may comprise one or more of smoothing the top surface, further compacting the surface (e.g. using a road roller), or allowing the surface to harden by known curing processes. The rock underlay permits any accumulated moisture to drain and disperse, thereby avoiding upheaval from freeze-thaw cycles. Similar techniques are used in the construction of runways, sidewalks, as well as bridge decks in which the underlay is placed on metal or other decking material instead of prepared soil. However, light-duty roads and sidewalks are sometimes constructed by depositing the pavement material directly on soil, or with one or both of the aforementioned rock or sand layers being omitted.

In an embodiment, the present sheet heater is incorporated in any of these road constructions by placing it atop the roadbed before the road surface layer is deposited and finished or by embedding it within the pavement material.

A related aspect of the present disclosure provides a heated paving module, comprising a pre-manufactured paver stone associated with a heater of any type as described above. The heater may either be adhered to the bottom of the paver or embedded therein. Most commonly, the pavers all have a single desired shape such as rectangular, square, or hexagonal, so that individual modules can be laid in adjacency to fully tile an area of an arbitrary larger size and shape. However, in other embodiments, a set of a small number of complementary tile shapes can be combined in a predetermined arrangement to accomplish a full tiling. The heater need not fully cover the bottom surface of each paver, but desirably at least a large portion of each is covered to attain reasonably uniform heating of the top surface. Normally, each module is abutted to its next neighbors, but small gaps may be acceptable.

A still further modular construction is contemplated, wherein the heater associated with each paving module comprises a heater, such as the implementation that uses a bottom layer of puncture-resistant material. In construction, a foam layer is first laid onto the roadbed as large sheets, and thereafter a plurality of the paving modules are situated on each sheet of the foam layer.

### EXAMPLE

The operation and effects of certain embodiments of the present invention may be more fully appreciated from the example described below. The embodiment on which this example is based is representative only, and the selection of this embodiment to illustrate aspects of the invention does not indicate that materials, components, conditions, techniques and/or configurations not described are not suitable for use herein, or that subject matter not described in the examples is excluded from the scope of the appended claims and equivalents thereof.

### Laboratory Simulation of Pavement De-icing System

A pavement de-icing system was simulated in the laboratory using a configuration similar to that depicted in FIG. 1. A backing layer of 5 cm thick closed-cell polystyrene board was placed on a laboratory cart. Two strips (30 cm×20 cm) of DuPont Kapton® RS Polyimide film were laid side by side on the backing layer to form the heater element and covered with a layer of DuPont TEMPRION™ OHS organic heat spreader. Then six concrete paving stones (30 cm×20 cm×5 cm thick) were assembled in a 60 cm square array.

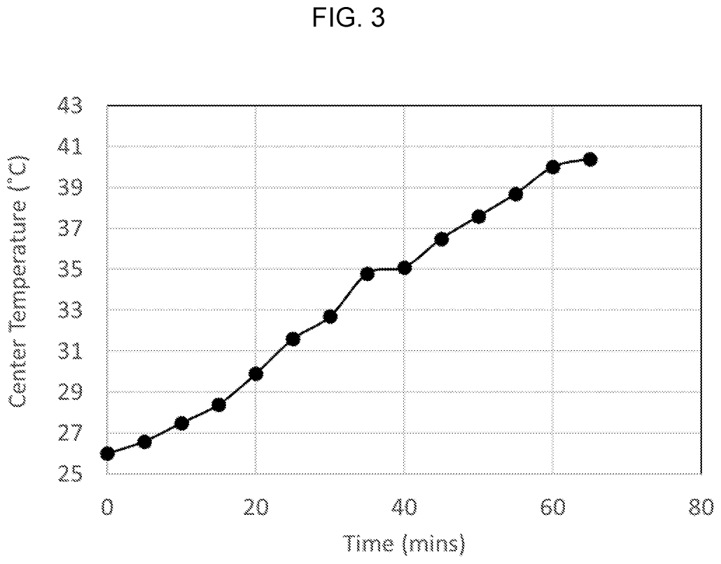

A temperature sensor was attached to the heater element and used to regulate a temperature controller, which provided controlled power to the heater element. During operation, the paving stones were imaged using a FLIR™ infrared camera, permitting the surface temperature to be monitored. The heating was activated with the controller at a set point of 60° C., with power applied at a density of 40 W/ft² (approximately 430 W/m²). The temperature at the center of the simulation area was recorded as a function of time. As set forth in FIG. 3, a temperature rise of about 15° C. over the lab ambient was attained in about 1 h, demonstrating the efficacy of the present heater system.

Having thus described the invention in rather full detail, it will be understood that this detail need not be strictly adhered to but that further changes and modifications may suggest themselves to one skilled in the art, all falling within the scope of the invention as defined by the subjoined claims.

The embodiments of the heater system and its constituent materials described herein, including the examples, are not limiting; it is contemplated that one of ordinary skill in the art could make minor substitutions and not substantially change the desired properties and operation of the system.

Where a range of numerical values is recited or established herein, the range includes the endpoints thereof and all the individual integers and fractions within the range, and also includes each of the narrower ranges therein formed by all the various possible combinations of those endpoints and internal integers and fractions to form subgroups of the larger group of values within the stated range to the same extent as if each of those narrower ranges was explicitly recited. Where a range of numerical values is stated herein as being greater than a stated value, the range is nevertheless finite and is bounded on its upper end by a value that is operable within the context of the invention as described herein. Where a range of numerical values is stated herein as being less than a stated value, the range is nevertheless bounded on its lower end by a non-zero value.

In this specification, unless explicitly stated otherwise or indicated to the contrary by the context of usage, where an embodiment of the subject matter hereof is stated or described as comprising, including, containing, having, being composed of, or being constituted by or of certain features or elements, one or more features or elements in addition to those explicitly stated or described may be present in the embodiment. An alternative embodiment of the subject matter hereof, however, may be stated or described as consisting essentially of certain features or elements, in which embodiment features or elements that would materially alter the principle of operation or the distinguishing characteristics of the embodiment are not present therein. A further alternative embodiment of the subject matter hereof may be stated or described as consisting of certain features or elements, in which embodiment, or in insubstantial variations thereof, only the features or elements specifically stated or described are present. Additionally, the term “comprising” is intended to include examples encompassed by the terms “consisting essentially of” and “consisting of.” Similarly, the term “consisting essentially of” is intended to include examples encompassed by the term “consisting of.”

Certain terminology may be employed herein for clarity and convenience of description, rather than for any limiting purpose. For example, the terms “forward,” “rearward,” “right,” “left,” “top,” “bottom,” “upper,” and “lower” designate directions in the drawings to which reference is made. The various drawings may depict the present heater oriented as it is intended to be installed and used atop a roadbed on the earth's surface or embedded in pavement situated atop the roadbed. Terminology of similar import other than the words specifically mentioned above likewise is to be considered as being used for purposes of convenience rather than in any limiting sense.

What is claimed is:

1. A puncture-resistant, electrically-energized sheet heater comprising:
(a) a flexible heater element having top and bottom surfaces;
(b) a puncture-resistant, polymeric protective layer laminated to the top surface of the flexible heating element;
(c) an insulating backing layer laminated to the bottom surface of the flexible heater element; and
(d) electrical terminals electrically connected to the flexible heater element, and configured such that current supplied by an electrical energy source and presented at the electrical terminals flows through the flexible heater element, whereby heat is produced by the heater.

2. The heater of claim 1, wherein the flexible heater element is a conductive polymeric film having an electrical conductivity characterized by a sheet resistance of 10-500 Ω/square.

3. The heater of claim 2, wherein the conductive polymeric film comprises a conductive polyimide.

4. The heater of claim 3, wherein the conductive polyimide comprises a conductive sublayer and a dielectric sublayer.

5. The heater of claim 2, wherein the conductive polymeric film comprises conductive particles dispersed therein.

6. The heater of claim 2, comprising a plurality of conductive polymeric films, each having top and bottom surfaces and an electrical conductivity characterized by a sheet resistance of 10-500 Ω/square, wherein the conductive polymeric films are disposed in stacked relationship with electrical insulation interspersed between surfaces of adjacent ones of the conductive polymeric films, and with the polymeric protective layer laminated to the top surface of the topmost of the conductive polymeric films and the foam backing layer laminated to the bottom surface of the bottommost of the conductive polymeric films.

7. The heater of claim 1, wherein the puncture-resistant, polymeric protective layer comprises at least one of an ultra-high molecular weight polyethylene sheet or a para-aramid sheet.

8. The heater of claim 7, wherein the puncture-resistant, polymeric protective layer comprises an even plurality of ultra-high molecular weight polyethylene sheets, each sheet having a machine direction, and the sheets being stacked with their machine directions in orthogonal, cross-ply alternation.

9. The heater of claim 1, wherein the backing layer comprises an open or closed cell foam board laminated to the bottom surface of the conductive polyimide film.

10. The heater of claim 9, wherein the backing layer comprises an extruded polystyrene closed-cell foam board.

11. The heater of claim 1, wherein the backing layer comprises a second puncture-resistant protective layer.

12. A heater system comprising:
(a) a sheet heater as recited by claim 1; and
(b) an electrical energy source electrically connected to the terminals of the sheet heater.

13. The heater system of claim 12, further comprising:
(c) a controller operable to control the energization of the sheet heater.

14. The heater system of claim 13, wherein the controller is operable to cause the heater to be energized such that a temperature measured at a measurement location thermally associated with the sheet heater is maintained between a lower set point and an upper set point.

15. The heater system of claim 13, wherein the controller is operable to cause the heater to be energized upon detection of frozen precipitation at a measurement location thermally associated with the sheet heater.

16. A heated paving module comprising a paver stone and a heater as recited by claim 1 associated with the paver stone.

17. A heated paving module, wherein the heater is adhered to the bottom of the paver stone.

18. A road, constructed with a pavement material that is at least one of concrete or bituminous asphalt and comprising a sheet heater as recited by claim 1 situated beneath, or embedded in, the pavement material.

19. A method for removing, or preventing build-up, of frozen precipitation from a paved road surface of a road, path, sidewalk, or the like comprising:
(a) providing a heater system as recited by claim 12;
(b) thermally contacting the heater with the pavement material; and
(c) energizing the heater sufficiently to maintain the road surface free of the frozen precipitation.

20. The method of claim 19, wherein the heater system further comprises a controller configured to detect the presence of frozen precipitation at a measurement location on the road surface and control the energization of the sheet heater in response thereto, and the controller is operable to energize the heater while frozen precipitation is present at the measurement location.
